(19) United States
(12) Patent Application Publication
(10) Pub. No.: US 2013/0076748 A1
(43) Pub. Date: Mar. 28, 2013

(54) 3D VISUALIZATION OF MEDICAL 3D IMAGE DATA

(71) Applicant: Siemens Aktiengesellschaft, Munich (DE)

(72) Inventor: Norbert RAHN, Forchheim (DE)

(73) Assignee: SIEMENS AKTIENGESELLSCHAFT, Munich (DE)

(21) Appl. No.: 13/625,260

(22) Filed: Sep. 24, 2012

(30) Foreign Application Priority Data
Sep. 28, 2011 (DE) 102011083635.7

(51) Int. Cl. G06T 17/00

(52) U.S. Cl. 345/424

(57) ABSTRACT

A method and apparatus are disclosed for displaying medical 3D image data. In an embodiment of the method, for every image voxel of the 3D image data which is assigned to a number g of the n regions, where g≧2: the transfer functions T₁(x), T₂(x), . . . , T_{g}(x) assigned to the g regions are applied to the image voxel value x. Each of the g transfer functions T_{1, . . . g}(x) assign the number m of parameter values to the image voxel value x, and mean parameter values P̅ₗ(x) are formed from the parameter values P_{j,l}(x). Regions visualized here are visualized on the basis of the mean parameter values P̅ₗ(x) for each image voxel of the 3D image data, which is assigned to the number g of the n regions.

### PRIORITY STATEMENT

The present application hereby claims priority under 35 U.S.C. §119 to German patent application number DE 10 2011 083 635.7 filed Sep. 28, 2011, the entire contents of which are hereby incorporated herein by reference.

### FIELD

At least one embodiment of the invention generally relates to a method and/or apparatus for the 3D visualization of medical 3D image data, as generated for example by a computed tomography system.

### BACKGROUND

In the prior art so-called volume rendering techniques (VRT) are used during 3D visualization to generate volume graphics from medical 3D image data. In this process corresponding parameter values for example for opacity, color, shading, etc. are allocated inter alia to the image points (image voxels) of the 3D image data using a predefined transfer function as a function of the image voxel value of the respective image voxel. This has the disadvantage that it is not possible to distinguish visually between different cohesive or uniform anatomical and/or morphological regions in the 3D image data, the image voxels of which have similar or identical image voxel values.

US 2005/0143654 A1 also discloses a method for the visualization of 3D image data, in which the 3D image data is segmented into different regions, with each region being allocated a transfer function and the image data being visualized on the basis of the transfer functions assigned respectively to the regions.

### SUMMARY

At least one embodiment of the invention is to specify a method and/or apparatus for displaying medical 3D image data, which allows a more user-friendly representation/display of 3D image data than the prior art.

Advantageous developments and embodiments are the subject matter of the dependent claims. Further features, application options and advantages of embodiments of the invention will emerge from the description which follows, as well as the explanation of example embodiments of the invention illustrated in the figures.

The method-related aspect of an embodiment is achieved with a method for displaying medical 3D image data, which has at least the following steps.

In a first step the 3D image data is supplied. The term medical “3D image data” is understood in broad terms in the present instance. It covers all 3-dimensional medical image data, which has image voxels with an assigned image voxel value in each instance.

In a second step a number n of regions is determined in the supplied 3D image data, where n≧2, with image voxels of the 3D image data being assigned correspondingly to the determined regions. The n regions are in particular 3D volume regions or 3D surfaces but can also be 2D regions, i.e. flat surfaces. The n regions are in particular defined by anatomically uniform structures, for example organs or tissue of an at least largely uniform material. The regions can also be defined by non-anatomical structures shown in the 3D image data, for example medical devices, catheters, etc. Thus anatomical and/or morphological regions are defined or determined in the 3D image data in this step. The regions in the 3D image data are preferably determined based on one or more segmentations of the supplied 3D image data.

In a third step a transfer function Tk(x) where k=1, . . . , n is predefined for each of the n regions. This assigns an individual transfer function Tk(x) to each of the n regions. The transfer function Tk(x) is preferably different for each region but this is not necessarily the case. In the present instance a transfer function Tk(x) allocates parameter values Pk,l(x) to an image voxel as a function of its image voxel value x for a predefined number m of parameters Pl, where:

x→Tₖ(x)=P_{k,l}(x) (1)

where:

k=1, . . . , n

l=1, . . . , m

n≧2, and

m≧1.

The parameter(s) Pl comprise(s) at least one of the following parameters: opacity, color, shading, brightness, contrast, pattern, surface emphasis or gloss effect. The parameter values Pk,l(x) correspondingly indicate the degree of opacity, color, brightness value, etc.

In a fourth step a visualization of the 3D image data or selected parts of the 3D image data is generated using a volume rendering method. Regions visualized here are visualized on the basis of the transfer function Tk(x) allocated respectively to the regions and the parameter values Pk,l(x) assigned respectively to the transfer functions.

In a last step the visualization, in other words the generated volume graphic, is displayed, for example on a monitor.

An apparatus is further disclosed for the visualization of medical 3D image data. An embodiment of the inventive apparatus comprises:

a first device, configured to supply the 3D image data,
a second device, configured to determine a number n of anatomical and/or morphological regions in the 3D image data, where n≧2, with image voxels of the 3D image data being assigned correspondingly to the determined regions,
a third device, configured to predefine a transfer function Tk(x) for each of the n regions, where k=1, . . . , n, with a transfer function Tk(x) allocating parameter values Pk,l(x) to an image voxel as a function of its image voxel value x for a number m of parameters Pl:

x→Tₖ(x)=P_{k,l}(x) (1)

where:

k=1, . . . , n

l=1, . . . , m

n≧2, and

m≧1,

and with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:

x→Tⱼ(x)=P_{j,l}(x), (2)

where:

j=1, . . . , g

l=1, . . . , m

g≧2≦n

m≧1, and

with mean parameter values P̅ₗ(x) being formed from the parameter values P_{j,l}(x), where l=1, . . . , m according to:

$${\overline{P}}_{l} ( x ) = \frac{1}{g} \cdot {\sum }_{t = 1}^{g} {P}_{t , l} ( x ) ,$$

a fourth device, configured to determine a visualization of the 3D image data or selected parts of the 3D image data using a volume rendering method, with anatomical and/or morphological regions visualized here being visualized on the basis of the transfer function Tₖ(x) allocated respectively to the regions and the parameter values P_{k,l}(x) assigned respectively to the transfer functions and with regions visualized here being visualized on the basis of the mean parameter values P̅ₗ(x) for each image voxel of the 3D image data assigned to the number g of the n regions, and
a fifth device, configured to display the visualization.

Further explanations, features and advantages of embodiments of the inventive apparatus will emerge by similarly applying the statements made above in conjunction with embodiments of the inventive method, to which reference is made for this purpose

### BRIEF DESCRIPTION OF THE DRAWINGS

Further advantages, features and details will emerge from the description which follows, in which example embodiments are described individually with reference to the drawings. Described and/or illustrated features per se or in any expedient combination form the subject matter of the invention, in some instances even independently of the claims, and can in particular also be the subject matter of one or more separate application(s). Parts that are identical, similar and/or of identical function are shown with identical reference characters. In the drawings specifically:

FIG. 1 shows a schematic representation of a flow diagram of an embodiment of an inventive method and

FIG. 2 shows a schematic diagram of an embodiment of an inventive apparatus.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The method-related aspect of an embodiment is achieved with a method for displaying medical 3D image data, which has the following steps.

In a first step the 3D image data is supplied. The term medical “3D image data” is understood in broad terms in the present instance. It covers all 3-dimensional medical image data, which has image voxels with an assigned image voxel value in each instance.

The 3D image data can be supplied for example from a storage medium, an imaging modality, for example a CT or NMR system, or from an image data processing system.

In a second step a number n of regions is determined in the supplied 3D image data, where n≧2, with image voxels of the 3D image data being assigned correspondingly to the determined regions. The n regions are in particular 3D volume regions or 3D surfaces but can also be 2D regions, i.e. flat surfaces. The n regions are in particular defined by anatomically uniform structures, for example organs or tissue of an at least largely uniform material. The regions can also be defined by non-anatomical structures shown in the 3D image data, for example medical devices, catheters, etc. Thus anatomical and/or morphological regions are defined or determined in the 3D image data in this step. The regions in the 3D image data are preferably determined based on one or more segmentations of the supplied 3D image data.

In a third step a transfer function Tk(x) where k=1, . . . , n is predefined for each of the n regions. This assigns an individual transfer function Tk(x) to each of the n regions. The transfer function Tk(x) is preferably different for each region but this is not necessarily the case. In the present instance a transfer function Tk(x) allocates parameter values Pk,l(x) to an image voxel as a function of its image voxel value x for a predefined number m of parameters Pl, where:

x→Tₖ(x)=P_{k,l}(x) (3)

where:

k=1, . . . , n

l=1, . . . , m

n≧2, and

m≧1.

The parameter(s) Pl comprise(s) at least one of the following parameters: opacity, color, shading, brightness, contrast, pattern, surface emphasis or gloss effect. The parameter values Pk,l(x) correspondingly indicate the degree of opacity, color, brightness value, etc.

In a fourth step a visualization of the 3D image data or selected parts of the 3D image data is generated using a volume rendering method. Regions visualized here are visualized on the basis of the transfer function Tk(x) allocated respectively to the regions and the parameter values Pk,l(x) assigned respectively to the transfer functions.

Therefore in the present instance a volume graphic is generated from the 3D image data using the transfer functions Tk(x) assigned to the respective regions, with the previously determined image regions, the image voxels of which have identical or approximately identical image voxel values in the supplied 3D image data for example, now being visualized differently in the volume graphic due to different transfer functions Tk(x).

In a last step the visualization, in other words the generated volume graphic, is displayed, for example on a monitor.

The volume graphic can in particular also comprise only selected parts of the 3D image data, for example “bowl-shaped” 3D image data, originating from the 3D image data in one or more segmentation steps. The volume graphic can in particular represent parts of the 3D image data visualized in it as a network structure with a surface, the surface elements (for example triangular surfaces) of which have properties which emerge on the basis of the transfer functions Tk(x).

The n regions are preferably determined by an operator based on a manual input, for example by interactively inputting into a corresponding input means. Alternatively the method can also be realized in such a manner that it is executed in an automated manner.

Typically the n regions do not overlap in the supplied 3D image data. Nevertheless applications are conceivable, in which there is overlapping of individual or all the n regions in the 3D image data.

In an embodiment of the inventive method, for each image voxel of the 3D image data, which is assigned to a number g of the supplied n regions and where g≧2, the transfer functions T1(x), T2(x), . . . , Tg(x) assigned to the g regions are first applied to the image voxel value x, with each of the g transfer functions T1, . . . g(x) assigning the number m of parameter values to the image voxel value x:

x→Tⱼ(x)=P_{j,l}(x) (2)

where:

j=1, . . . , g

l=1, . . . , m

g≧2≦n, and

m≧1,

with mean parameter values P̅ₗ(x) being formed from the parameter values P_{j,l}(x), where l=1, . . . , m according to:

$${\overline{P}}_{l} ( x ) = \frac{1}{g} \cdot {\sum }_{t = 1}^{g} {P}_{t , l} ( x ) ,$$

and
with regions visualized here being visualized on the basis of the mean parameter values P̅ₗ(x) for each image voxel of the 3D image data, which is assigned to the number g of the n regions.

Therefore g sets of parameter values Pj,l(x) are assigned to each image voxel, which is assigned to more than one, in the present instance therefore a number of g regions.

According to an embodiment of the invention mean parameter values P̅ₗ(x) are then formed from the parameter values Pj,l(x), according to:

$${\overline{P}}_{l} ( x ) = \frac{1}{g} \cdot {\sum }_{t = 1}^{g} {P}_{t , l} ( x ) ,$$

where l=1, . . . , m. The mean is therefore taken over the parameters of the individual transfer functions.

The following example serves to clarify an embodiment of the inventive method. Let it be assumed that some image voxels of the 3D image data are assigned to two determined regions, in other words g=2. Let the transfer function T1(x) be allocated to the first of the regions and the transfer function T2(x) be allocated to the second of the regions. Let it also be assumed that the transfer functions T1(x) and T2(x) respectively assign an opacity and color to an image voxel value x, in other words two parameters or corresponding parameter values determining the parameter, in other words m=2 also.

When applying the first transfer function T1(x) to the image voxel value x therefore the parameter values P1,1(x) and P1,2(x) result. When applying the second transfer function T2(x) to the image voxel value x therefore the parameter values P2,1(x) and P2,2(x) result. The mean parameter value P̅₁(x) comes out as ½*(P1,1(x)+P2,1(x)). The mean parameter value P̅₂(x) comes out as ½*(P1,2(x)+P2,2(x)).

Finally according to an embodiment of the invention a visualization of the 3D image data or selected parts of the 3D image data is generated using a volume rendering method, with regions visualized here being visualized on the basis of the mean parameter values P̅ₗ(x) for each image voxel of the 3D image data, which is assigned to more than one of the n anatomical and/or morphological regions.

The 3D image data of the n regions is preferably stored with the assigned transfer functions Tk(x). This allows different volume graphics to be generated quickly by applying different visualization methods.

An apparatus is further disclosed for the visualization of medical 3D image data. An embodiment of the inventive apparatus comprises:

a first device, configured to supply the 3D image data,
a second device, configured to determine a number n of anatomical and/or morphological regions in the 3D image data, where n≧2, with image voxels of the 3D image data being assigned correspondingly to the determined regions,
a third device, configured to predefine a transfer function Tk(x) for each of the n regions, where k=1, . . . , n, with a transfer function Tk(x) allocating parameter values Pk,l(x) to an image voxel as a function of its image voxel value x for a number m of parameters Pl:

x→Tₖ(x)=P_{k,l}(x) (1)

where:

k=1, . . . , n

l=1, . . . , m

n≧2, and

m≧1,

and with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:

x→Tⱼ(x)=P_{j,l}(x), (4)

where:

j=1, . . . , g

l=1, . . . , m

g≧2≦n

m≧1, and

with mean parameter values P̅ₗ(x) being formed from the parameter values P_{j,l}(x), where l=1, . . . , m according to:

$${\overline{P}}_{l} ( x ) = \frac{1}{g} \cdot {\sum }_{t = 1}^{g} {P}_{t , l} ( x ) ,$$

a fourth device, configured to determine a visualization of the 3D image data or selected parts of the 3D image data using a volume rendering method, with anatomical and/or morphological regions visualized here being visualized on the basis of the transfer function Tₖ(x) allocated respectively to the regions and the parameter values P_{k,l}(x) assigned respectively to the transfer functions and with regions visualized here being visualized on the basis of the mean parameter values P̅ₗ(x) for each image voxel of the 3D image data assigned to the number g of the n regions, and
a fifth device, configured to display the visualization.

One advantageous development of an embodiment of the inventive apparatus includes a sixth device being present, useable by an operator to determine the n regions in the 3D image data manually.

The objective of the concept described here is to assign a 3D visualization with different opacities, colors and shading to different medical 3D image content, referred to in the following as “2D or 3D regions”, using a so-called volume rendering technique, as different anatomical structures, the image points of which are present in the same gray-scale value region, require different transfer functions to distinguish the different morphological structures visually and represent them separately from one another. Thus for example a stent or bone or an anatomical region to which contrast agent has been administered can be visualized in the same 3D visualization based respectively on a different transfer function. In this process regions are defined in supplied medical 3D image data and different transfer functions are applied to the regions.

The regions can be defined and visualized here not only on the basis of voxel-based 3D image data but also for example on the basis of “bowl-shaped” segmentation results, which can in turn be divided into regions.

The regions can be determined in different ways. For example a user can manually determine different regions in the 3D image data, for example simply by drawing them in or by interactive segmentation. The regions can also be drawn in on a 3D visualization of the 3D image data using a corresponding input means and then have a punch effect for example, with a cylindrical region being generated in the 3D image data by the drawing of a circle. The cylinder axis here preferably runs perpendicular to an input plane and is therefore a function of the orientation of the 3D visualization. The regions can also be determined as 3D regions such as cubes, cuboids, ellipsoids, spheres. The regions can be marked in an MPR visualization or in a 3D-VRT visualization. The regions can also be determined automatically by applying an image data processing operation (e.g. segmentation), for example to suggest a determination of the regions to a user, which said user can then accept, reject or modify.

The application of a number of 2D or 3D region determinations is generally possible in order ultimately to define 3D regions of any complexity (and in some instances a number of complex 3D regions), with overlapping regions also being possible.

If two or more regions are not determined, all the image voxels to be visualized are transferred to a volume graphic based on a single transfer function.

Each of the determined n regions or even a combination of a number of the n regions can be selected and then allocated a transfer function. In other words each of said n regions is allocated its own transfer function (including options for varying opacity and/or color and/or shading and/or contrast and/or surface emphasis and/or gloss effects), for example by means of a user interaction. A number of for example trapezoidal curves relating to the transfer function can be defined and superimposed for each of these n regions, to change the parameters of the representation. A change can be made to the region-specific transfer functions by way of a corresponding editor, for example a drop-down menu of the regions (left side of screen) and names and visualization properties of the transfer functions for the respective region (right side of screen).

Spatial overlapping of the regions is permitted, as mentioned above. Where individual regions overlap, the transfer functions are duplicated and averaged in the gray-scale value overlap region. All other properties, such as color, shading, contrast, surface emphasis, gloss effects, are also averaged in the spatial overlap regions.

Both the structures of the regions and the associated visualization properties can be stored separately or combined at any time. Storage is study-specific or series-specific and it is possible both to store permanently in a system database of a visualization workstation and to send for example to PACS or HIS/RIS systems for archiving.

Both the n regions and the associated visualization properties/parameter(s) (values) can be used separately or combined at any time for visualization. Any combinations of the regions can be activated/deactivated, in other words set to “show” or “hide” or parts of the visualization properties, e.g. gloss effects, can be activated or deactivated. If one or more regions are deactivated, a global transfer function can optionally be used for said regions.

The described principle can not only be applied to 3D image data, but also to the inner and outer surfaces of a “3D dish”, for example on a triangular grid, as generated by segmenting the 3D image data. The triangles of the grid associated with a determined region are then represented with the corresponding visualization properties (parameter values).

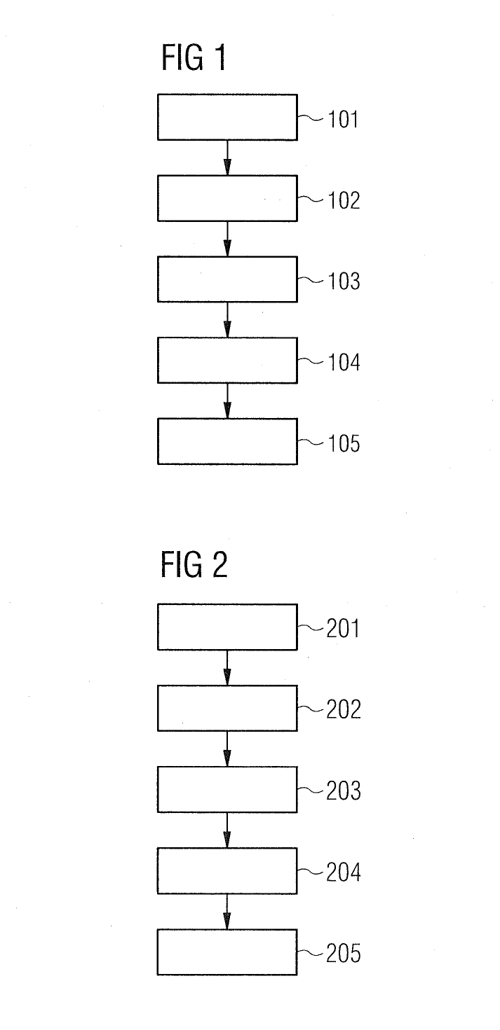

FIG. 1 shows a schematic representation of a flow diagram of an embodiment of an inventive method for displaying medical 3D image data. The method comprises the following steps.

In a first step 101 the 3D image data is supplied.

In a second step 102 a number n of regions is determined in the 3D image data, where n≧2, with image voxels of the 3D image data being assigned correspondingly to the determined regions.

In a third step 103 a transfer function Tk(x) where k=1, . . . , n is predefined for each of the n regions, with a transfer function Tk(x) allocating parameter values Pk,l(x) to an image voxel as a function of its image voxel value x for a number m of parameters Pl:

x→Tₖ(x)=P_{k,l}(x) (1)

where:

k=1, . . . , n

l=1, . . . , m

n≧2, and

m≧1,

and with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:

x→Tⱼ(x)=P_{j,l}(x), (5)

where:

j=1, . . . , g

l=1, . . . , m

g≧2≦n

m≧1, and

with mean parameter values P̅ₗ(x) being formed from the parameter values P_{j/l}(x), where l=1, . . . , m according to:

$${\overline{P}}_{l} ( x ) = \frac{1}{g} \cdot {\sum }_{t = 1}^{g} {P}_{t , l} ( x ) .$$

In a fourth step 104 a visualization of the 3D image data or selected parts of the 3D image data is generated using a volume rendering method with regions visualized here being visualized on the basis of the transfer function Tk(x) allocated respectively to the regions and the parameter values Pk,l(x) assigned respectively to the transfer functions and with regions visualized here being visualized on the basis of the mean parameter values P̅ₗ(x) for each image voxel of the 3D image data, which is assigned to the number g of the n regions.

In a fifth step 105 the visualization is displayed.

FIG. 2 shows a schematic diagram of an embodiment of an inventive apparatus for the visualization of medical 3D image data, comprising:

a first device 201, configured to supply the 3D image data,
a second device 202, configured to determine a number n of regions in the 3D image data, where n≧2, with image voxels of the 3D image data being assigned correspondingly to the determined regions,
a third device 203, configured to predefine a transfer function Tk(x) for each of the n regions, where k=1, . . . , n, with a transfer function Tk(x) allocating parameter values Pk,l(x) to an image voxel as a function of its image voxel value x for a number m of parameters Pl:

x→Tₖ(x)=P_{k,l}(x) (1)

where:

k=1, . . . , n

l=1, . . . , m

n≧2, and

m≧1,

and with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:

x→Tᵢ(x)=P_{j,l}(x), (2)

where:

j=1, . . . , g

l=1, . . . , m

g≧2≦n

m≧1, and

with mean parameter values P̅ₗ(x) being formed from the parameter values P_{j/l}(x), where l=1, . . . , m according to:

$${\overline{P}}_{l} ( x ) = \frac{1}{g} \cdot {\sum }_{t = 1}^{g} {P}_{t , l} ( x ) ,$$

a fourth device 204, configured to determine a visualization of the 3D image data or selected parts of the 3D image data using a volume rendering method, with regions visualized here being visualized on the basis of the transfer function Tₖ(x) allocated respectively to the regions and the parameter values P_{k,l}(x) assigned respectively to the transfer functions and with regions visualized here being visualized on the basis of the mean parameter values P̅ₗ(x) for each image voxel of the 3D image data assigned to the number g of the n regions, and
a fifth device 205, configured to display the visualization.

Even though the invention has been illustrated and explained in greater detail using preferred exemplary embodiments, the invention is not restricted by the disclosed examples and other variations can be derived therefrom by the person skilled in the art, without departing from the scope of protection of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for displaying medical 3D image data, comprising:
supplying the 3D image data;
determining a number (n) of regions in the 3D image data, where n≧2, with image voxels of the 3D image data being assigned correspondingly to the determined regions;
defining, for each of the n regions, a transfer function Tₖ(x) where k=1, . . . , n, with a transfer function Tₖ(x) allocating parameter values P_{k,l}(x) to an image voxel as a function of its image voxel value x for a number m of parameters Pₗ:
x→Tₖ(x)=P_{k,l}(x) (1)
where:
k=1, . . . , n
l=1, . . . , m
n≧2, and
m≧1,
generating a visualization of the 3D image data or selected parts of the 3D image data using a volume rendering method, with regions visualized here being visualized on the basis of the transfer function Tₖ(x) allocated respectively to the regions and the parameter values P_{k,l}(x) assigned respectively to the transfer functions; and
displaying the generated visualization, wherein for each image voxel of the 3D image data, which is assigned to a number g of the n regions, where g≧2:
the transfer functions T₁(x), T₂(x), . . . , T_{g}(x) assigned to the g regions are applied to the image voxel value x, with each of the g transfer functions T_{1, . . . g}(x) assigning the number m of parameter values to the image voxel value x:
x→Tⱼ(x)=P_{j,l}(x) (2)
where:
j=1, . . . , g
l=1, . . . , m
g≧2≦n, and
m≧1,
with mean parameter values P̅ₗ(x) being formed from the parameter values P_{j,l}(x), where l=1, . . . , m according to:
$${\overline{P}}_{l} ( x ) = \frac{1}{g} \cdot {\sum }_{t = 1}^{g} {P}_{t , l} ( x ) , \qquad ( 3 )$$
and
with regions visualized here being visualized on the basis of the mean parameter values P̅ₗ(x) for each image voxel of the 3D image data, which is assigned to the number g of the n regions.

2. The method of claim 1, wherein the regions are determined by an operator based on a manual input.

3. The method of claim 1, wherein the method is executed in an automated manner.

4. The method of claim 1, wherein the parameters Pₗ comprise at least one of the following parameters: opacity, color, shading, brightness, contrast, pattern, surface emphasis and gloss effect.

5. The method of claim 1, wherein the transfer functions Tₖ(x) assigned to the regions differ in each instance.

6. The method of claim 1, wherein the 3D image data of the n regions is stored with the assigned transfer functions Tₖ(x).

7. The method of claim 1, wherein the regions in the 3D image data are determined based on one or more segmentations of the supplied 3D image data.

8. An apparatus for the visualization of medical 3D image data, comprising:
a first device, configured to supply the 3D image data;
a second device, configured to determine a number n of regions in the 3D image data, where n≧2, with image voxels of the 3D image data being assigned correspondingly to the determined regions;
a third device, configured to define a transfer function Tₖ(x) for each of the n regions, where k=1, . . . , n, with a transfer function Tₖ(x) allocating parameter values P_{k,l}(x) to an image voxel as a function of its image voxel value x for a number m of parameters Pₗ:
x→Tₖ(x)=P_{k,l}(x) (1)
where:
k=1, . . . , n
l=1, . . . , m
n≧2, and
m≧1
with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:
x→Tⱼ(x)=P_{j,l}(x) (2)
where:
j=1, . . . , g
l=1, . . . , m
g≧2≦n,
m≧1, and
with mean parameter values P̅ₗ(x) being formed from the parameter values P_{j,l}(x), where l=1, . . . , m according to:
$${\overline{P}}_{l} ( x ) = \frac{1}{g} \cdot {\sum }_{t = 1}^{g} {P}_{t , l} ( x ) , \qquad ( 3 )$$
a fourth device, configured to determine a visualization of the 3D image data or selected parts of the 3D image data using a volume rendering method, with regions visualized here being visualized on the basis of the transfer function Tₖ(x) allocated respectively to the regions and the parameter values P_{k,l}(x) assigned respectively to the transfer functions and with regions visualized here being visualized on the basis of the mean parameter values P̅ₗ(x) for each image voxel of the 3D image data assigned to the number g of the n regions; and
a fifth device, configured to display the visualization.

9. The apparatus of claim 8, further comprising:
a sixth device, useable by an operator, configured to determine the regions in the 3D image data manually.

10. An apparatus for the visualization of medical 3D image data, comprising:
means for supplying the 3D image data;
means for determining a number n of regions in the 3D image data, where n≧2, with image voxels of the 3D image data being assigned correspondingly to the determined regions;
means for defining a transfer function Tₖ(x) for each of the n regions, where k=1, . . . , n, with a transfer function Tₖ(x) allocating parameter values P_{k,l}(x) to an image voxel as a function of its image voxel value x for a number m of parameters Pₗ:
x→Tₖ(x)=P_{k,l}(x) (1)
where:
k=1, . . . , n
l=1, . . . , m
n≧2, and
m≧1
with the transfer functions T₁(x), T₂(x), . . . , T_{g}(x) assigned to the g regions being applied to the image voxel value x for each image voxel of the 3D image data, which is assigned to a number g of the n regions, where g≧2, with each of the g transfer functions T_{1, . . . g}(x) assigning the number m of parameter values to the image voxel value x:
x→Tⱼ(x)=P_{j,l}(x) (2)
where:
j=1, . . . , g
l=1, . . . , m
g≧2≦n,
m≧1, and
with mean parameter values P̅ₗ(x) being formed from the parameter values P_{j,l}(x), where l=1, . . . , m according to:
$${\overline{P}}_{l} ( x ) = \frac{1}{g} \cdot {\sum }_{t = 1}^{g} {P}_{t , l} ( x ) , \qquad ( 3 )$$
means for determining a visualization of the 3D image data or selected parts of the 3D image data using a volume rendering method, with regions visualized here being visualized on the basis of the transfer function Tₖ(x) allocated respectively to the regions and the parameter values P_{k,l}(x) assigned respectively to the transfer functions and with regions visualized here being visualized on the basis of the mean parameter values P̅ₗ(x) for each image voxel of the 3D image data assigned to the number g of the n regions; and
means for displaying the visualization.

11. The apparatus of claim 10, further comprising:
means for determining, by an operator, the regions in the 3D image data manually.
